(19) United States
(12) Patent Application Publication
(10) Pub. No.: US 2025/0012651 A1
(43) Pub. Date: Jan. 9, 2025

(54) TACTILE SENSOR UNIT AND ROBOT ARM UNIT

(71) Applicant: SONY GROUP CORPORATION, TOKYO (JP)

(72) Inventors: TOMOKO KATSUHARA, TOKYO (JP); HIROYUKI SHIGEI, TOKYO (JP); TETSUYA NARITA, TOKYO (JP); TEPPEI TAKAHASHI, TOKYO (JP)

(21) Appl. No.: 18/712,313

(22) PCT Filed: Oct. 12, 2022
(86) PCT No.: PCT/JP2022/038025

§ 371 Date: May 22, 2024

(30) Foreign Application Priority Data
Nov. 30, 2021 (JP) 2021-194908

(51) Int. Cl. G01L 5/22; B25J 19/02; G01L 1/24

(52) U.S. Cl. CPC G01L 5/228; B25J 19/021; G01L 1/24

(57) ABSTRACT

A tactile sensor unit according to one embodiment of the present disclosure includes a pin-hole layer, an optical sensor, a plurality of light sources, a deformation layer, and a marker. The pin-hole layer has a plurality of pin-holes and a plurality of first through holes. The optical sensor is disposed at a position opposed to the plurality of pin-holes via a predetermined gap. The plurality of light sources is disposed in a layer between the pin-hole layer and the optical sensor, at locations respectively opposed to the plurality of through holes. The deformation layer is disposed at a position on a side opposite to the plurality of light sources in a positional relationship with respect to the pin-hole layer. The marker is disposed on a surface of the deformation layer or inside of the deformation layer.

### TECHNICAL FIELD

The present disclosure relates to a tactile sensor unit and a robot arm unit.

### BACKGROUND ART

In order to control handling of an object by a robot, a large number of sensors are used in the robot. For example, PTL 1 below discloses the sensors to be used in the robot.

### CITATION LIST

### Patent Literature

PTL 1: JP 6864401 B1

### SUMMARY OF THE INVENTION

Incidentally, a sensor is required to be downsized to apply the sensor to a distal end portion of a robot arm. In particular, in a case where a vision-type contact sensor that uses a camera to measure surface displacement of the distal end portion of the robot arm is applied to the distal end portion of the robot arm, a device is increased in size by an amount corresponding to a focal length of the camera. Further, in a case where reflection light of light from a light source is used at the time of measurement by the camera, there is a possibility that stray light becomes a noise to cause reduction of detection sensitivity. Accordingly, it is desirable to provide a tactile sensor unit and a robot arm unit that each allow downsizing and stray light suppression to be achieved.

A tactile sensor unit according to a first embodiment of the present disclosure includes a pin-hole layer, an optical sensor, a plurality of light sources, a deformation layer, and a marker. The pin-hole layer has a plurality of pin-holes and a plurality of first through holes. The optical sensor is disposed at a position opposed to the plurality of pin-holes via a predetermined gap. The plurality of light sources is disposed in a layer between the pin-hole layer and the optical sensor, at locations respectively opposed to the plurality of through holes. The deformation layer is disposed at a position on a side opposite to the plurality of light sources in a positional relationship with respect to the pin-hole layer. The marker is disposed on a surface of the deformation layer or inside of the deformation layer.

A robot arm unit according to a second embodiment of the present disclosure includes one or a plurality of the above-described tactile sensor units.

The tactile sensor unit according to the first embodiment to the present disclosure and the robot arm unit according to the second embodiment to the present disclosure each use a plurality of pin-holes. This allows an optical path length to be shortened and also allows a depth of field to be increased as compared with a case of using a lens. In a case where the pin-holes are used to shorten the optical path length, it is possible to reduce the size of the tactile sensor unit itself. Further, in the present disclosure, the plurality of light sources is disposed in a layer between the pin-hole layer and the optical sensor, at locations respectively opposed to the plurality of through holes 12b. This prevents light emitted from each light source from directly entering the pin-hole, and hence it is possible to suppress stray light.

### BRIEF DESCRIPTION OF DRAWING

FIG. 1 is a diagram illustrating a cross-sectional configuration example of a tactile sensor unit according to one embodiment of the present disclosure.

FIG. 2 is a diagram describing an arrangement of pin-holes in the tactile sensor unit of FIG. 1.

FIG. 3 is a diagram illustrating a planar configuration example of a pin-hole layer of FIG. 1.

FIG. 4 is a diagram illustrating a planar configuration example of a light blocking layer of FIG. 1.

FIG. 5 is a diagram illustrating a planar configuration example of a light emitting substrate of FIG. 1.

FIG. 6 is a diagram illustrating a planar configuration example of a sensor substrate of FIG. 1.

FIG. 7 is a diagram illustrating one modification example of a planar configuration of the sensor substrate of FIG. 1.

FIG. 8 is a diagram illustrating a planar configuration example of a marker of FIG. 1.

FIG. 9 is a diagram illustrating an example of deformation of the marker when the light blocking layer of FIG. 1 is pressed from outside.

FIG. 10 is a diagram illustrating one modification example of the cross-sectional configuration of the tactile sensor unit of FIG. 1.

FIG. 11 is a diagram illustrating one modification example of the cross-sectional configuration of the tactile sensor unit of FIG. 1.

FIG. 12 is a diagram illustrating a planar configuration example of a Fresnel layer of FIG. 11.

FIG. 13 is a diagram illustrating one modification example of the cross-sectional configuration of the tactile sensor unit of FIG. 1.

FIG. 14 is a diagram illustrating one modification example of the cross-sectional configuration of the tactile sensor unit of FIG. 1.

FIG. 15 is a diagram illustrating one modification example of the cross-sectional configuration of the tactile sensor unit of FIG. 10.

FIG. 16 is a diagram illustrating one modification example of the cross-sectional configuration of the tactile sensor unit of FIG. 11.

FIG. 17 is a diagram illustrating one modification example of the cross-sectional configuration of the tactile sensor unit of FIG. 13.

FIG. 18 is a diagram illustrating one modification example of the cross-sectional configuration of the tactile sensor unit of FIG. 1.

FIG. 19 is a diagram illustrating one modification example of the cross-sectional configuration of the tactile sensor unit of FIG. 10.

FIG. 20 is a diagram illustrating one modification example of the cross-sectional configuration of the tactile sensor unit of FIG. 11.

FIG. 21 is a diagram illustrating one modification example of the cross-sectional configuration of the tactile sensor unit of FIG. 13.

FIG. 22 is a diagram illustrating one modification example of the cross-sectional configuration of the tactile sensor unit of FIG. 1.

FIG. 23 is a diagram illustrating one modification example of the cross-sectional configuration of the tactile sensor unit of FIG. 10.

FIG. 24 is a diagram illustrating one modification example of the cross-sectional configuration of the tactile sensor unit of FIG. 11.

FIG. 25 is a diagram illustrating one modification example of the cross-sectional configuration of the tactile sensor unit of FIG. 13.

FIG. 26 is a diagram illustrating an example of an exterior appearance of a robot apparatus in which the above-described tactile sensor unit is applied to a distal end portion of a robot arm unit.

### MODES FOR CARRYING OUT THE INVENTION

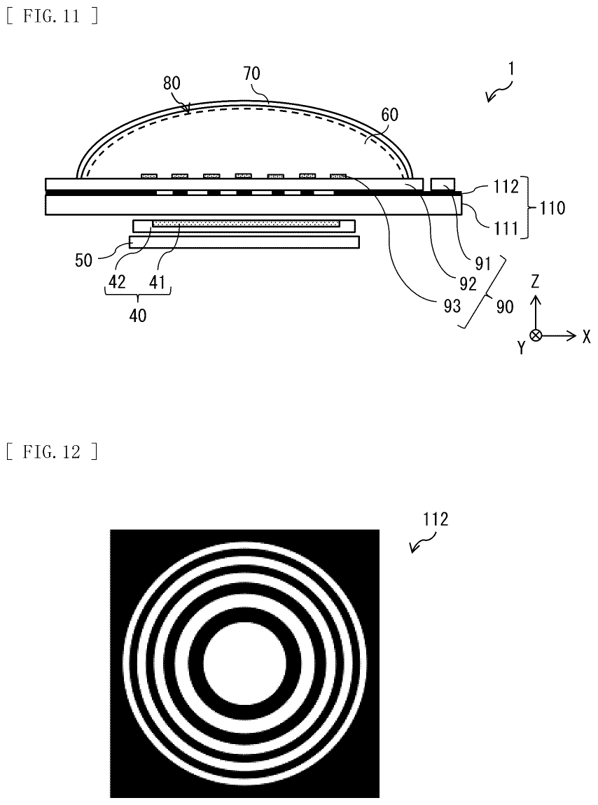

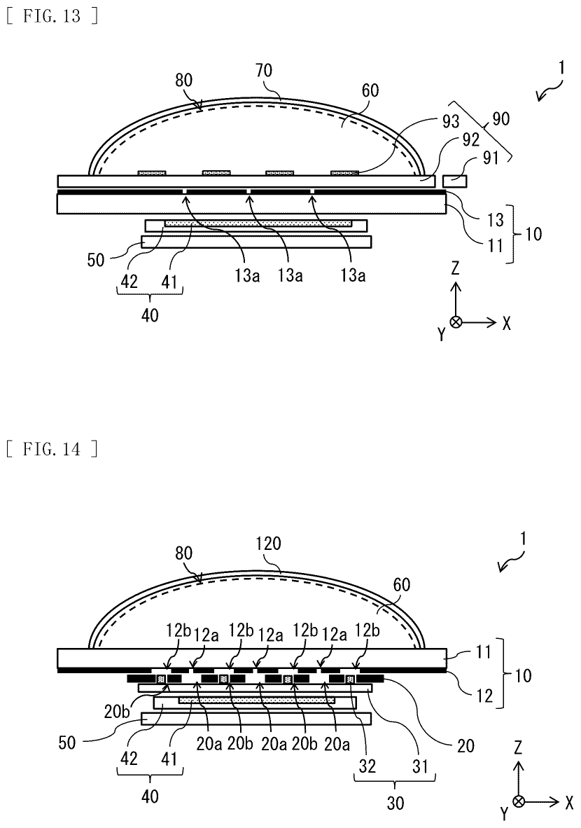

In the following, some embodiments of the present disclosure will be described in detail with reference to the drawings. The following description is one specific example of the present disclosure, and the present disclosure is not limited to the following embodiments. In addition, the arrangement, dimensions, dimension ratios, and the like of components illustrated in each drawing in the present disclosure are also not limited to those embodiments. It is to be noted that the description will be given in the following order.
1. Embodiment (Tactile Sensor Unit):
   an example in which a light source is provided at a position closer to a sensor with respect to a pin-hole (FIG. 1 to FIG. 9)
2. Modification Examples (Tactile Sensor Unit)
   Modification Example A: an example in which a light guide plate is used as the light source (FIG. 10)
   Modification Example B: an example in which a Fresnel layer is used in place of the pin-hole (FIG. 11, FIG. 12)
   Modification Example C: an example in which the light guide plate is provided on the pin-hole (FIG. 13)
   Modification Example D: an example in which a surface in contact with the outside is formed of a transparent layer (FIG. 14 to FIG. 17)
   Modification Example E: an example in which a dome-shaped air gap is provided in place of a deformation layer (FIG. 18 to FIG. 21)
   Modification Example F: an example in which the air gap is provided by using a spacer (FIG. 22 to FIG. 25)
3. Application Example (Robot Apparatus):
   an example in which the above-described tactile sensor unit is applied to a distal end portion of a robot arm unit (FIG. 26)

### 1. EMBODIMENT

### (Configuration)

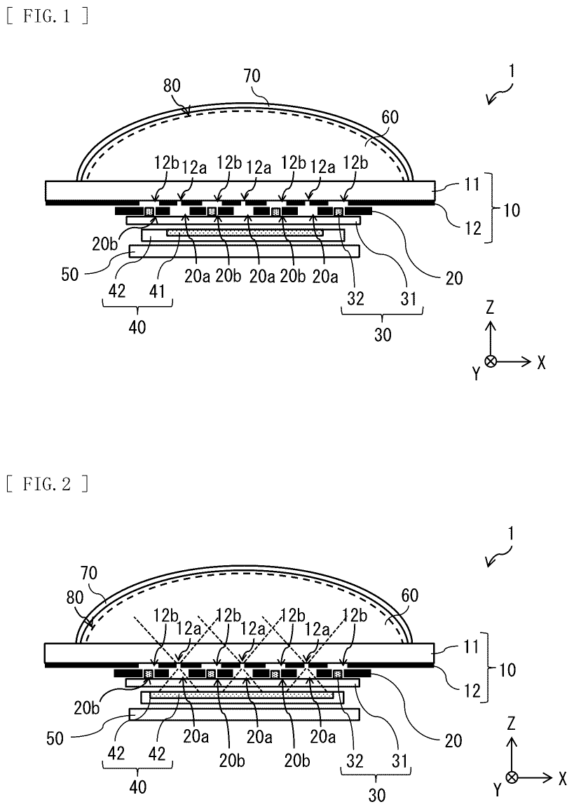

Description is given of a tactile sensor unit 1 according to one embodiment of the present disclosure. FIG. 1 illustrates a cross-sectional configuration example of the tactile sensor unit 1. FIG. 2 is a diagram describing an arrangement of pin-holes 12a (described later) in the tactile sensor unit 1. The tactile sensor unit 1 is a device suitably applicable as a sensor that detects contact of a distal end portion of a robot arm unit to an external object.

The tactile sensor unit 1 includes, for example, as illustrated in FIG. 1 and FIG. 2, a pin-hole substrate 10, a light blocking layer 20, a light emitting substrate 30, a sensor substrate 40, and a controller substrate 50. The tactile sensor unit 1 further includes, for example, as illustrated in FIG. 1, a deformation layer 60, a light blocking layer 70, and a marker 80.

### (Pin-Hole Substrate 10)

The pin-hole substrate 10 includes a pin-hole layer 12 and a support 11 that supports the pin-hole layer 12. The support 11 is a substrate formed of a transparent material. The support 11 is, for example, a glass substrate. The thickness of the glass substrate that may be used as the support 11 is, for example, about 0.7 mm. Here, “transparent” refers to a state of having a light transmitting characteristic with respect to at least light emitted from a light emitting device 32 to be described later. It suffices that the support 11 have a light transmitting characteristic in a level that allows functions of the tactile sensor unit 1 to be implemented.

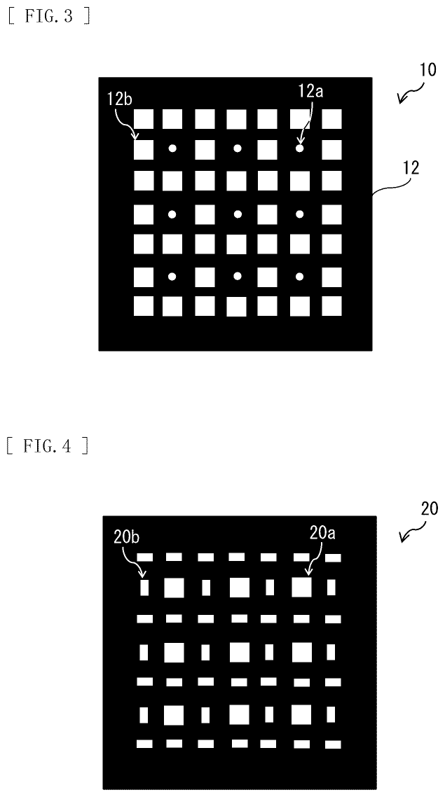

The pin-hole layer 12 is disposed in contact with a back surface of the support 11 (surface on the light emitting substrate 30 side). The pin-hole layer 12 is formed of an opaque material. Here, “opaque” refers to a state of having a light blocking characteristic with respect to at least light emitted from the light emitting device 32. The pin-hole layer 12 has a plurality of pin-holes 12a. It suffices that the pin-hole layer 12 have a light blocking characteristic in a level that allows functions of the pin-holes 12a to be implemented. The pin-hole layer 12 further has a plurality of through holes 12b. Each of the through holes 12b is formed in a region opposed to at least the light emitting device 32 to be described layer. In plan view, the size of the through hole 12b is larger than at least the size of the pin-hole 12a, and is larger than the size of the light emitting device 32. The inner diameter of the pin-hole 12a is, for example, uniform, and is, for example, 29 μm to 50 μm. The inner diameter of the pin-hole 12a may vary between the support 11 side and the light emitting substrate 30 side. An opening of the pin-hole 12a has, for example, as illustrated in FIG. 3, a circular shape. An opening of the through hole 12b has, for example, as illustrated in FIG. 3, a rectangular shape.

The plurality of pin-holes 12a is, for example, as illustrated in FIG. 2 and FIG. 3, two-dimensionally disposed in the pin-hole layer 12. The plurality of pin-holes 12a is, for example, as indicated by the broken lines of FIG. 2, disposed at positions at which image light beams formed by the respective pin-holes 12a do not overlap each other on a surface of a sensor section 41 to be described later. An array pitch of the plurality of pin-holes 12a is, for example, about 2.4 mm. The plurality of through holes 12b is, for example, as illustrated in FIG. 2 and FIG. 3, two-dimensionally disposed in the pin-hole layer 12, and is disposed to surround each pin-hole 12a.

### (Light Blocking Layer 20)

The light blocking layer 20 is disposed in contact with the pin-hole layer 12, and is disposed on the light emitting substrate 30 and sensor substrate 40 side in a positional relationship with respect to the pin-hole substrate 10. That is, the light blocking layer 20 is disposed in a region between the pin-hole layer 12 and each of the light emitting substrate 30 and the sensor substrate 40. The light blocking layer 20 is formed of an opaque material similarly to the pin-hole layer 12. The light blocking layer 20 has a plurality of through holes 20a and a plurality of through holes 20b. The light blocking layer 20 corresponds to one specific example of a “first light blocking layer” of the present disclosure. The through hole 20a corresponds to one specific example of a “second through hole” of the present disclosure. The through hole 20b corresponds to one specific example of a “third through hole” of the present disclosure.

The through hole 20a is provided at a position opposed to the pin-hole 12a, and communicates with the pin-hole 12a. In plan view, the size of the through hole 20a is larger than at least the size of the pin-hole 12a. The size of the through hole 20a is, as indicated by the broken lines of FIG. 2, set to a size corresponding to an amount that prevents the light blocking layer 20 from blocking the image light formed by the pin-hole 12a. The through hole 20b is provided at a position opposed to the through hole 12b, and communicates with the through hole 12b. In plan view, the size of the through hole 20b is smaller than at least the size of the through hole 12b, and is a size that allows the light emitting device 32 to be accommodated therein. An opening of the through hole 20a has, for example, as illustrated in FIG. 4, a rectangular shape. An opening of the through hole 20b has, for example, as illustrated in FIG. 4, a rectangular shape.

The plurality of through holes 20a is, for example, as illustrated in FIG. 4, two-dimensionally disposed in the light blocking layer 20. The plurality of through holes 20b is, for example, as illustrated in FIG. 4, two-dimensionally disposed in the light blocking layer 20 and is disposed to surround each through hole 20a.

### (Light Emitting Substrate 30)

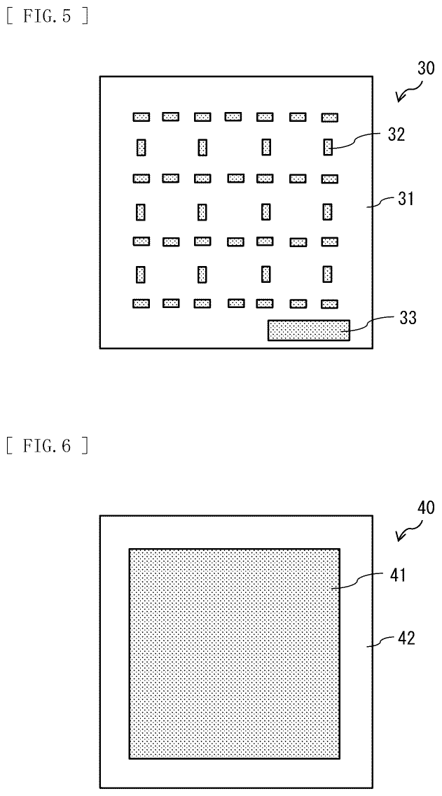

The light emitting substrate 30 includes, for example, as illustrated in FIG. 1 and FIG. 5, a transparent substrate 31, a wiring layer (not illustrated) formed on the transparent substrate 31, a plurality of light emitting devices 32 coupled to the wiring layer, and a driver 33 coupled to the plurality of light emitting devices 32 via the wiring layer. The light emitting device 32 corresponds to one specific example of a “light source” of the present disclosure. The transparent substrate 31 is a substrate formed of a transparent material. The transparent substrate 31 is, for example, a glass substrate. Here, “transparent” refers to a state of having a light transmitting characteristic with respect to at least light emitted from the light emitting device 32. It suffices that the transparent substrate 31 have a light transmitting characteristic in a level that allows the functions of the tactile sensor unit 1 to be implemented.

The wiring layer is a layer including wiring lines that electrically couple the plurality of light emitting devices 32 and the driver 33 to each other. The wiring layer is, for example, formed at a portion opposed to at least each light emitting device 32 and the driver 33, and has an opening at a portion opposed to at least each through hole 20a. The plurality of light emitting devices 32 is disposed in a layer between the pin-hole substrate 10 and the sensor substrate 40, at locations respectively opposed to the plurality of through holes 12b. The plurality of light emitting devices 32 is, for example, as illustrated in FIG. 5, two-dimensionally disposed in the light emitting substrate 30. The light emitting device 32 is, for example, a semiconductor light-emitting diode (LED) or an organic light-emitting diode (OLED). The light emitting device 32 applies light to the deformation layer 60 via the through holes 20b and 12b. The light emitting device 32 applies light at a predetermined divergence angle with respect to a normal direction of the light emitting substrate 30. The light emitting device 32 is, for example, a device that emits light in a visible range. It is to be noted that the light emitting device 32 may be, for example, a device that emits light in a range other than the visible range (for example, infrared range).

The light emitting device 32 is accommodated in the through hole 20a. That is, the light emitting device 32 is disposed in the same layer as the light blocking layer 20, and is disposed at a position at which light emitted from the light emitting device 32 does not directly enter the pin-hole 12a. For example, the light blocking layer 20 is bonded to a front surface of the light emitting substrate 30 (surface on the light emitting device 32 side). This allows the light emitting device 32 to be accommodated in the through hole 20a. The driver 33 is an IC chip that controls light emission and extinction of the plurality of light emitting devices 32. The plurality of light emitting devices 32 and the driver 33 are, for example, mounted on the wiring layer.

### (Sensor Substrate 40)

The sensor substrate 40 is disposed to be opposed to the pin-hole substrate 10 through intermediation of the light emitting substrate 30. The sensor substrate 40 includes a sensor section 41 and a drive substrate 42 that drives the sensor section 41. The sensor section 41 corresponds to one specific example of an “optical sensor” of the present disclosure. The sensor section 41 is disposed at a position opposed to the plurality of pin-holes 2a via a predetermined gap. The sensor section 41 detects light that has entered the sensor section 41 via the plurality of pin-holes 12a. The sensor section 41 is, for example, a camera that generates image data by receiving image light formed by each pin-hole 12a. This camera includes a charge coupled device (CCD) image sensor or a complementary metal oxide semiconductor (CMOS) image sensor. This camera has, for example, sensitivity to a wavelength range of at least light emitted from the light emitting device 32. This camera has, for example, sensitivity to light in a visible range. It is to be noted that this camera may have, for example, sensitivity to light in a range other than the visible range (for example, infrared range).

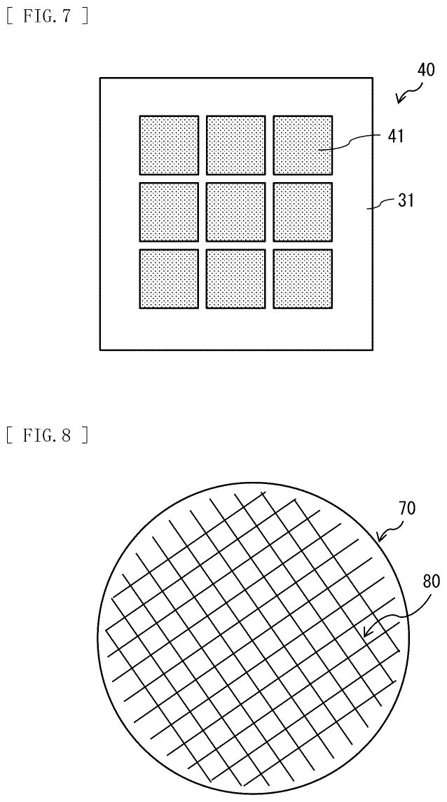

The sensor section 41 is disposed in a region that allows the sensor section 41 to receive the image light formed by each pin-hole 12a. A light receiving surface of the sensor section 41 is, for example, as illustrated in FIG. 6, disposed in a region opposed to all of the pin-holes 12a. It is to be noted that the light receiving surface of the sensor section 41 may be, for example, as illustrated in FIG. 7, an aggregate of a plurality of light receiving surfaces separated from each other. A distance between the light receiving surface of the sensor section 41 and each pin-hole 12a is, for example, about 1.1 mm.

### (Controller Substrate 50)

The controller substrate 50 is, for example, disposed on a back surface of the sensor substrate 40. The controller substrate 50 includes a control IC that controls light emission and extinction in the light emitting substrate 30 or light reception in the sensor substrate 40. The control IC outputs, for example, a control signal for controlling the light emission and extinction to the light emitting substrate 30 via a wire that couples the controller substrate 50 and the light emitting substrate 30 to each other. The control IC outputs, for example, a control signal for controlling the light reception to the sensor substrate 40 via a wire that couples the controller substrate 50 and the sensor substrate 40 to each other.

The control IC outputs, for example, image data obtained from the sensor substrate 40 to the outside (for example, a controller that controls an operation of a robot in a robot apparatus). The controller of the robot apparatus estimates, for example, three-dimensional deformation of each portion of the surface of the tactile sensor unit 1 (surface of the light blocking layer 70) or a force (vector) applied to each portion of the surface of the tactile sensor unit 1 (surface of the light blocking layer 70), on the basis of data such as a plurality of pieces of image data having detection times different from each other, which has been obtained from the tactile sensor unit 1. The controller of the robot apparatus controls, for example, an actuator of the robot on the basis of information obtained through such estimation.

### (Deformation Layer 60)

The deformation layer 60 deforms in accordance with a physical stimulation applied from the outside (for example, displacement in a vertical direction (pressing) or displacement in a shear direction (rubbing)). The deformation layer 60 is disposed at a position on a side opposite to the plurality of light emitting devices 32 in a positional relationship with respect to the pin-hole layer 12. The deformation layer 60 is disposed in contact with an upper surface of the support 11 (surface on a side opposite to the surface in contact with the pin-hole layer 12). The deformation layer 60 is disposed at a position opposed to the plurality of light emitting devices 32. The deformation layer 60 is a substrate formed of a transparent material. The deformation layer 60 is, for example, formed of a rubber material. Here, “transparent” refers to a state of having a light transmitting characteristic with respect to at least light emitted from the light emitting device 32. It suffices that the deformation layer 60 have a light transmitting characteristic in a level that allows the functions of the tactile sensor unit 1 to be implemented. The deformation layer 60 has, for example, as illustrated in FIG. 1, a dome shape. In a case where the deformation layer 60 has the dome shape, it is possible to measure incipient slip that occurs when an object comes into contact from the outside.

### (Light Blocking Layer 70)

The light blocking layer 70 is disposed in contact with the surface of the deformation layer 60. The light blocking layer 70 corresponds to one specific example of a “second light blocking layer” of the present disclosure. The light blocking layer 70 is disposed to cover the deformation layer 60 and the marker 80, and has a function of blocking leakage of light (light of the light emitting device 32) that has propagated through the deformation layer 60 to the outside. The light blocking layer 70 is formed of an opaque material having a refractive index larger than a refractive index of the support 11. Here, “opaque” refers to a state of having a light blocking characteristic with respect to at least light emitted from the light emitting device 32.

In a case where the support 11 is formed of a glass substrate (refractive index of 1.46), the deformation layer 60 is formed of, for example, a material having a refractive index of 1.5.

This allows light of a wide angle of view to enter each pin-hole 12a.

### (Marker 80)

The marker 80 is, for example, disposed between the deformation layer 60 and the light blocking layer 70. The marker 80 is, for example, disposed on the surface of the deformation layer 60 or inside of the deformation layer 60. The marker 80 is, for example, disposed in contact with a front surface of the deformation layer 60 (surface in contact with the light blocking layer 70), and is, for example, formed by printing onto the surface of the deformation layer 60 or embedding beads into the surface of the deformation layer 60. The marker 80 functions as a reflection layer that reflects at least light of the light emitting device 32. The marker 80 is formed of a material having a reflecting characteristic with respect to at least light emitted from the light emitting device 32. The marker 80 has, for example, as illustrated in FIG. 8, a grid shape. It is to be noted that the shape of the marker 80 is not limited to the grid shape, and may be, for example, a dot shape.

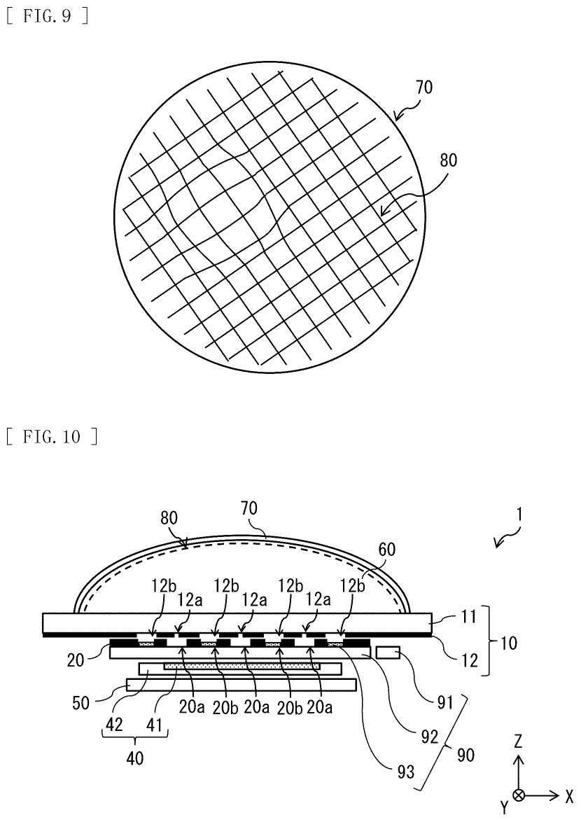

In a case where the marker 80 has a grid shape, when a portion of the light blocking layer 70 is pressed by a finger, the marker 80 deforms into such a shape that, for example, as illustrated in FIG. 9, a portion of the grid is expanded. At this time, the image data obtained by the sensor section 41 may include a marker image having such a shape that a portion of the grid is expanded.

### (Operation)

Next, the operation of the tactile sensor unit 1 according to this embodiment is described.

The controller substrate 50 outputs, to the light emitting substrate 30, a control signal for causing each light emitting device 32 to emit light. Then, the driver 33 drives each light emitting device 32, and each light emitting device 32 emits light. The light emitted from each light emitting device 32 reaches the deformation layer 60 via the through holes 20b and 12b, and is reflected by the marker 80. Part of light (reflection light) reflected by the marker 80 is refracted at an interface between the deformation layer 60 and the support 11 to enter each pin-hole 12a. The light that has entered each pin-hole 12a irradiates the surface of the sensor section 41 at a predetermined angle of view. As a result, an image including a portion of the marker 80 is formed on the surface of the sensor section 41. The sensor section 41 generates image data including the image formed by each pin-hole 12a, which is output to the outside via the controller substrate 50.

### Effect

Next, an effect of the tactile sensor unit 1 according to this embodiment is described.

In order to control handling of an object by a robot, a large number of sensors are used in a robot. A sensor is required to be downsized to apply the sensor to a distal end portion of a robot arm.

In particular, in a case where a vision-type contact sensor that uses a camera to measure surface displacement of the distal end portion of the robot arm is applied to the distal end portion of the robot arm, a device is increased in size by an amount corresponding to a focal length of the camera. Further, in a case where reflection light of light from a light source is used at the time of measurement by the camera, there is a possibility that stray light becomes a noise to cause reduction of detection sensitivity.

Meanwhile, in this embodiment, the plurality of pin-holes 12a is used in place of a lens. This allows an optical path length to be shortened and also a depth of field to be increased as compared with the case of using the lens. In a case where the pin-holes 12a are used to shorten the optical path length, it is possible to reduce the size of the tactile sensor unit 1 itself. Moreover, it is possible to widen the angle of view, and hence it is possible to widen a detection region by disposing the plurality of pin-holes 12a in an array pattern. Further, as a result of the increased depth of field, it is possible to widen the dynamic range. Further, in this embodiment, each light emitting device 32 is disposed in a region in which the light emitting device 32 is sandwiched between the sensor section 41 and the pin-hole layer 12 in the stacking direction, the region being outside from the angle of view of the pin-hole 12a. This prevents light emitted from each light emitting device 32 from directly entering the pin-hole 12a, and hence it is possible to suppress stray light. Accordingly, it is possible to achieve downsizing and stray light suppression.

In this embodiment, the light blocking layer 20 is disposed in the same layer as the plurality of light emitting devices 32. This prevents light emitted from each light emitting device 32 from directly entering the pin-hole 12a, and hence it is possible to suppress stray light. Accordingly, it is possible to achieve downsizing and stray light suppression.

In this embodiment, the light blocking layer 70 that covers the deformation layer 60 and the marker 80 is disposed. This makes it possible to prevent the distal end of the robot arm from shining when the tactile sensor unit 1 is disposed at the distal end of the robot arm.

In this embodiment, the marker 80 that functions as the reflection layer is provided. This allows displacement of the marker 80 to be measured by detecting light (reflection light) reflected by the marker 80.

### 2. MODIFICATION EXAMPLES

### Modification Example A

In the above-described embodiment, for example, as illustrated in FIG. 10, a light source section 90 may be provided at the position of the light emitting substrate 30 in place of the light emitting substrate 30. The light source section 90 includes, for example, a light source 91, a light guide plate 92, a plurality of scattering layers 93, and a driver.

The light source 91 includes a light emitting device that applies light to an end surface of the light guide plate 92. The light emitting device is, for example, a semiconductor light-emitting diode or an organic light-emitting diode. The light emitting device is, for example, a device that emits light in a visible range. It is to be noted that the light emitting device may be, for example, a device that emits light in a range other than the visible range (for example, infrared range). The light emitted from the light emitting device propagates through the light guide plate 92 via the end surface of the light guide plate 92. The driver is an IC chip that controls light emission and extinction of the light source 91.

The light guide plate 92 is disposed between the sensor substrate 40 (sensor section 41) and the light blocking layer 20. The plurality of scattering layers 93 is disposed in contact with a front surface of the light guide plate 92 (surface on the light blocking layer 20 side). Each of the plurality of scattering layers 93 is disposed at a position opposed to a corresponding one of the plurality of through holes 12b, and is accommodated in a corresponding one of the plurality of through holes 12b. The plurality of scattering layers 93 extracts light that has propagated through the light guide plate 92 from the light guide plate 92 to apply the extracted light to the deformation layer 60 via the through holes 20b and 12b. The scattering layer 93 applies light at a predetermined divergence angle with respect to a normal direction of the light guide plate 92. As described above, each scattering layer 93 functions as the light emitting device 32 in the above-described embodiment.

The scattering layer 93 outputs the light propagating through the light guide plate 92 toward the marker 80 via the through holes 20b and 12b. The scattering layer 93 corresponds to one specific example of the “light source” of the present disclosure. The scattering layer 93 is disposed in the same layer as the light blocking layer 20, and is disposed at a position at which light emitted from the scattering layer 93 does not directly enter the pin-hole 12a. For example, the light blocking layer 20 is bonded to a front surface of the light guide plate 92 (surface on the scattering layer 93 side). This allows the scattering layer 93 to be accommodated in the through hole 20a.

In this modification example, the controller substrate 50 outputs, to the light source section 90, a control signal for causing the light source 91 to emit light. Then, the driver drives the light source 91, and the light source 91 emits light. The light emitted from the light source 91 propagates through the light guide plate 92, and is then scattered by each scattering layer 93. Light generated by the scattering at each scattering layer 93 reaches the deformation layer 60 via the through holes 20b and 12b, and is reflected by the marker 80. Part of light (reflection light) reflected by the marker 80 is refracted at the interface between the deformation layer 60 and the support 11 to enter each pin-hole 12a. The light that has entered each pin-hole 12a irradiates the surface of the sensor section 41 at a predetermined angle of view. As a result, an image including a portion of the marker 80 is formed on the surface of the sensor section 41. The sensor section 41 generates image data including the image formed by each pin-hole 12a, which is output to the outside via the controller substrate 50.

In this modification example, the light that has propagated through the light guide plate 92 is extracted by the scattering layer 93, and is output toward the marker 80 via the through holes 20b and 12b. This allows the thickness of the tactile sensor unit 1 to be reduced as compared with the case of providing the light emitting substrate 30.

### Modification Example B

In Modification Example A described above, for example, as illustrated in FIG. 11, a Fresnel substrate 110 may be provided in place of the pin-hole substrate 10 and the light blocking layer 20. The Fresnel substrate 110 includes a Fresnel layer 112 and a support 111 that supports the Fresnel layer 112. The support 111 is a substrate formed of a transparent material. The support 111 is, for example, a glass substrate. The thickness of the glass substrate that may be used for the support 111 is, for example, about 0.7 mm. Here, “transparent” refers to a state of having a light transmitting characteristic with respect to at least light emitted from the light emitting device 32. It suffices that the support 111 have a light transmitting characteristic in a level that allows the functions of the tactile sensor unit 1 to be implemented.

The Fresnel layer 112 is disposed in contact with a front surface of the support 111 (surface on the deformation layer 60 side). The Fresnel layer 112 is formed of an opaque material. Here, “opaque” refers to a state of having a light blocking characteristic with respect to at least light emitted from the light source 91. The Fresnel layer 112 has, for example, as illustrated in FIG. 12, a pattern of concentric stripes. It suffices that the Fresnel layer 112 have a light blocking characteristic in a level that allows functions of a Fresnel zone plate to be implemented.

In this modification example, the light source section 90 is disposed between the Fresnel substrate 110 and the deformation layer 60. The light guide plate 92 is disposed in contact with the Fresnel layer 112 of the Fresnel substrate 110. The plurality of scattering layers 93 is disposed in contact with the front surface of the light guide plate 92 (surface on the deformation layer 60 side). Each of the plurality of scattering layers 93 is disposed at a position opposed to a light blocking portion within the Fresnel pattern.

In this modification example, the controller substrate 50 outputs, to the light source section 90, a control signal for causing the light source 91 to emit light. Then, the driver drives the light source 91, and the light source 91 emits light. The light emitted from the light source 91 propagates through the light guide plate 92, and is then scattered by each scattering layer 93. Light generated by the scattering at each scattering layer 93 reaches the marker 80 via the deformation layer 60, and is reflected by the marker 80. Part of light (reflection light) reflected by the marker 80 is refracted at an interface between the deformation layer 60 and the support 111 to enter the Fresnel layer 112. The light that has entered the Fresnel layer 112 is condensed through interference in the Fresnel layer 112, and irradiates the surface of the sensor section 41. As a result, an image including the marker 80 is formed on the surface of the sensor section 41. The sensor section 41 generates image data including the image formed by the Fresnel layer 112, which is output to the outside via the controller substrate 50.

In this modification example, the Fresnel substrate 110 is provided. This allows the light efficiency to be improved because an opening area is wider as compared with the case where the pin-hole substrate 10 is provided. As a result, it is possible to acquire a bright image. Further, even when power of the light source 91 is suppressed to be low, it is possible to acquire a bright image equivalent to that in the case where the pin-hole substrate 10 is provided.

### Modification Example C

In Modification Example B described above, for example, as illustrated in FIG. 13, at the position of the Fresnel substrate 110, the pin-hole substrate 10 may be provided in place of the Fresnel substrate 110.

In this modification example, the pin-hole substrate 10 includes a pin-hole layer 13 and a support 11 that supports the pin-hole layer 13. The pin-hole layer 13 is disposed in contact with an upper surface of the support 11 (surface on the light source section 90 side). The pin-hole layer 13 is formed of an opaque material. Here, “opaque” refers to a state of having a light blocking characteristic with respect to at least light emitted from the light source 91. The pin-hole layer 13 has a plurality of pin-holes 13a. It suffices that the pin-hole layer 13 have a light blocking characteristic in a level that allows functions of the pin-holes 13a to be implemented. The inner diameter of the pin-hole 13a is, for example, uniform, and is, for example, 29 μm to 50 μm. The inner diameter of the pin-hole 13a may vary between the support 11 side and the light source section 90 side. An opening of the pin-hole 13a has, for example, a circular shape.

The plurality of pin-holes 13a is, for example, two-dimensionally disposed in the pin-hole layer 13. The plurality of pin-holes 13a is, for example, disposed at positions at which image light beams formed by the respective pin-holes 13a do not overlap each other on the surface of the sensor section 41. An array pitch of the plurality of pin-holes 13a is, for example, about 2.4 mm.

In this modification example, the light source section 90 is disposed between the pin-hole substrate 10 and the deformation layer 60. The light guide plate 92 is disposed in contact with the pin-hole layer 13 of the pin-hole substrate 10. The plurality of scattering layers 93 is disposed in contact with the front surface of the light guide plate 92 (surface on the deformation layer 60 side). In plan view, each of the plurality of scattering layers 93 is disposed at a position that is not opposed to each pin-hole 13a.

In this modification example, the controller substrate 50 outputs, to the light source section 90, a control signal for causing the light source 91 to emit light. Then, the driver drives the light source 91, and the light source 91 emits light. The light emitted from the light source 91 propagates through the light guide plate 92, and is then scattered by each scattering layer 93. Light generated by the scattering at each scattering layer 93 reaches the marker 80 via the deformation layer 60, and is reflected by the marker 80. Part of light (reflection light) reflected by the marker 80 is refracted at an interface between the deformation layer 60 and the light guide plate 92 to enter each pin-hole 12a. The light that has entered each pin-hole 12a irradiates the surface of the sensor section 41 at a predetermined angle of view. As a result, an image including a portion of the marker 80 is formed on the surface of the sensor section 41. The sensor section 41 generates image data including the image formed by each pin-hole 12a, which is output to the outside via the controller substrate 50.

In this modification example, the light source section 90 is disposed on the pin-hole substrate 10. This allows the light blocking layer 20 to be omitted, and thus it is possible to achieve the tactile sensor unit 1 with a simple configuration.

### Modification Example D

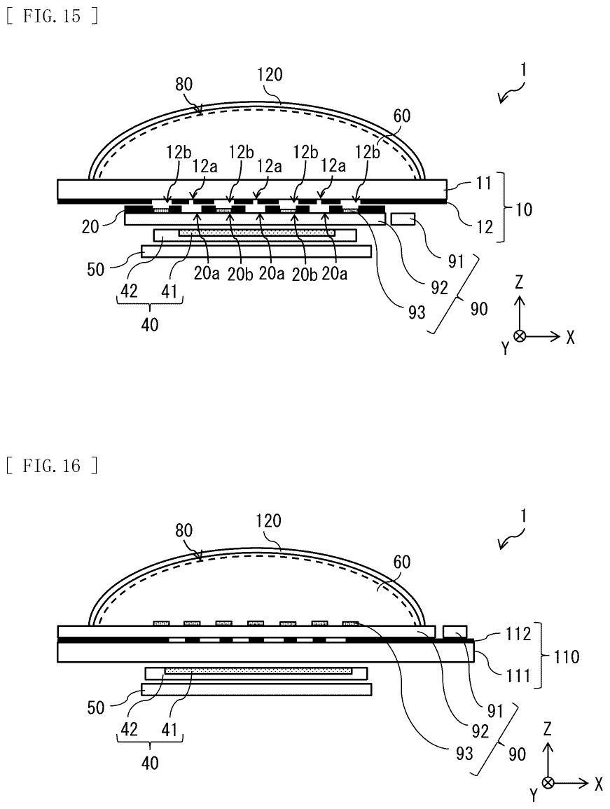

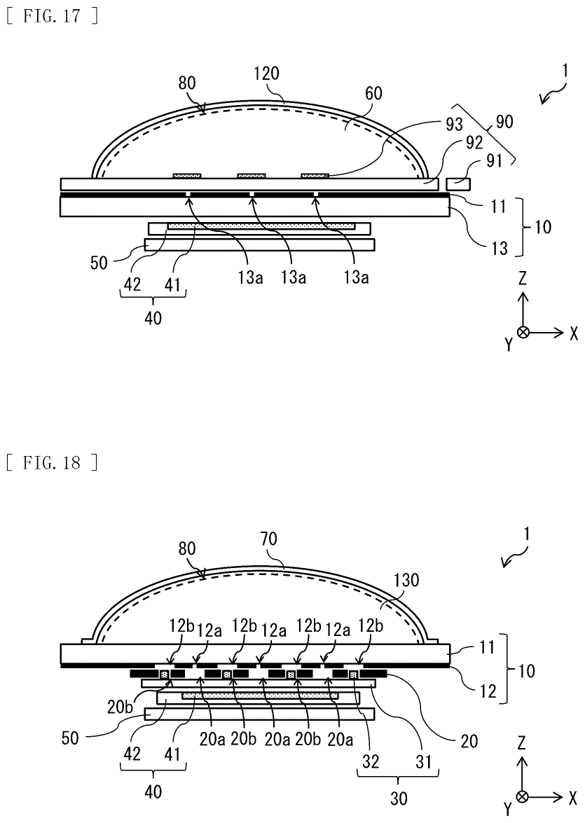

In the embodiment and its modification examples described above, for example, as illustrated in FIG. 14, FIG. 15, FIG. 16, and FIG. 17, at the position of the light blocking layer 70, a transparent layer 120 may be provided in place of the light blocking layer 70. The transparent layer 120 is a light transmitting layer that is disposed to cover the deformation layer 60 and the marker 80, and transmits external light. The transparent layer 120 is a flexible layer formed of a transparent material. The transparent layer 120 is, for example, formed of a rubber material having a light transmitting characteristic. Here, “transparent” refers to a state of having a light transmitting characteristic with respect to at least external light (light in a visible range). In this modification example, the sensor section 41 has sensitivity to not only a wavelength range of light emitted from the light emitting device 32 or the light source 91, but also a wavelength range of external light (visible range). In a case where the sensor section 41 emits light in a visible range, the sensor section 41 has sensitivity to light in the visible range.

In this modification example, the marker 80 reflects the light emitted from the light emitting device 32 or the light source 91. Not only part of light (reflection light) reflected by the marker 80, but also part of light (light in the visible range) that has entered the sensor section 41 from the outside via the transparent layer 120 enters the sensor section 41. In this manner, the image data generated by the sensor section 41 may include not only the marker 80 but also an object present in an external environment near the tactile sensor unit 1. As a result, for example, it is possible for the tactile sensor unit 1 to detect an external object approaching the tactile sensor unit 1 before the tactile sensor unit 1 touches the external object. Accordingly, in the robot apparatus including the sensor unit 1, for example, it is possible to control the operation of the robot arm to enable the robot arm to successfully grasp the approaching external object, on the basis of the image data obtained from the sensor unit 1.

### Modification Example E

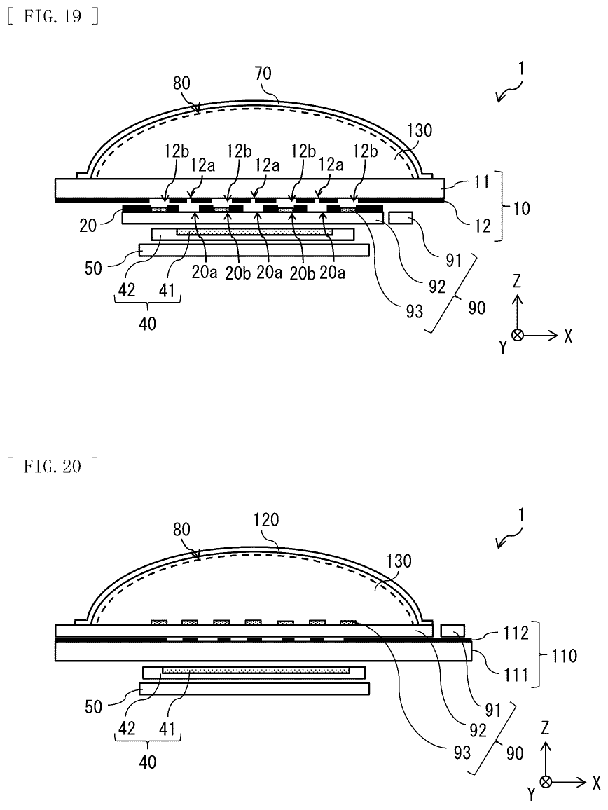

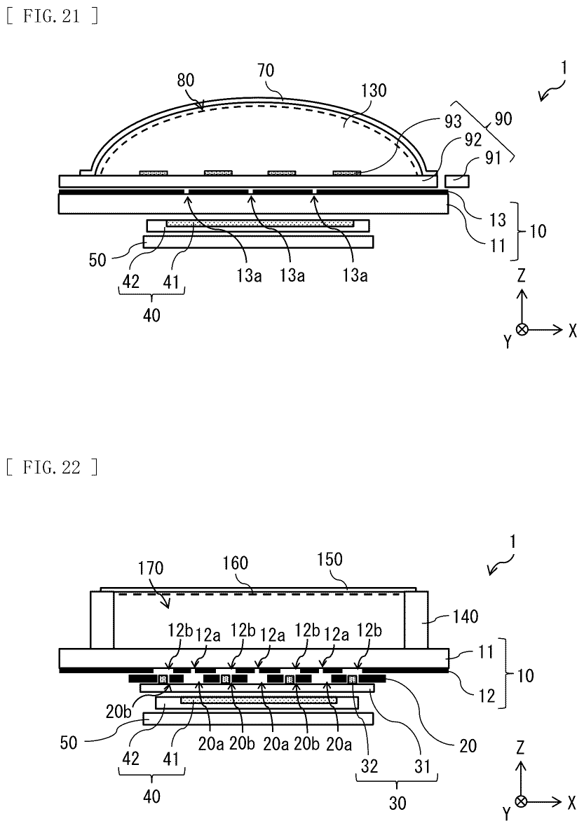

In the embodiment and its modification examples described above, for example, as illustrated in FIG. 18, FIG. 19, FIG. 20, and FIG. 21, at the position of the deformation layer 60, an air gap 130 may be provided in place of the deformation layer 60. The air gap 130 is surrounded by the light blocking layer 70 and the support 11 or the light guide plate 92. The air gap 130 may be sealed (tightly-sealed) by the light blocking layer 70 and the support 11 or the light guide plate 92, or the air gap 130 may be charged with, for example, atmosphere or gas such as nitrogen. In such a case, when the light blocking layer 70 is pressed from the outside by an object and then the object separates away from the light blocking layer 70, it is possible to restore the shape of the light blocking layer 70 to the shape before the pressing with the elasticity of the air gap 130.

It is to be noted that the air gap 130 is not necessarily tightly-sealed. Further, in this modification example, the transparent layer 120 may be provided in place of the light blocking layer 70.

### Modification Example F

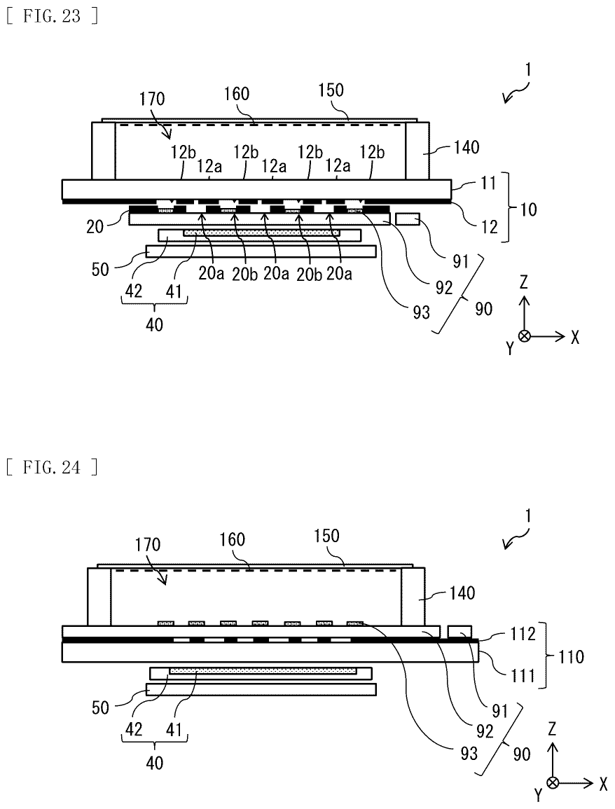

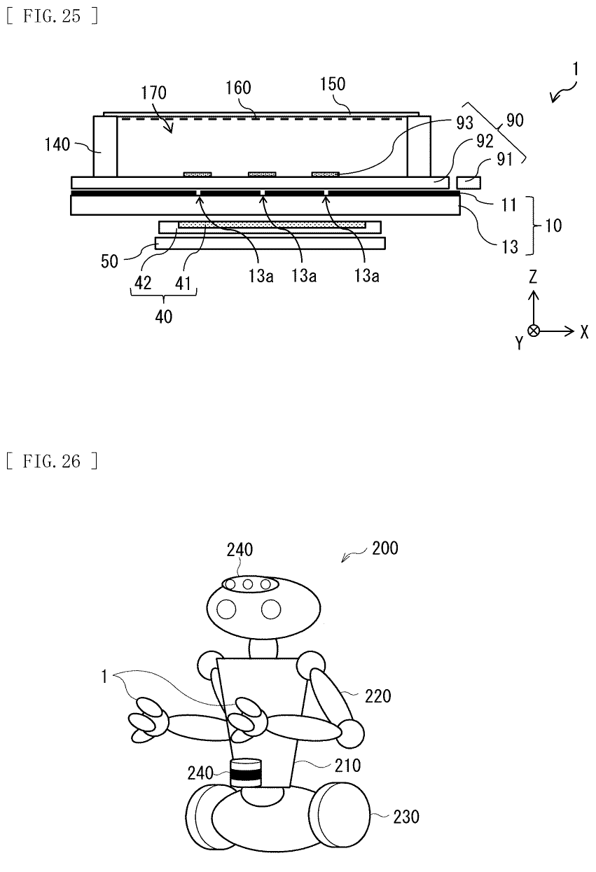

In the embodiment and its modification examples described above, for example, as illustrated in FIG. 22, FIG. 23, FIG. 24, and FIG. 25, a spacer 140, a light blocking layer 150, and a marker 160 may be provided in place of the light blocking layer 70 and the marker 80.

The spacer 140 supports edges of the light blocking layer 150 and the marker 160. The spacer 140 has a tubular shape, and forms an air gap 170 in a region between the support 11 or the light guide plate 92 and each of the light blocking layer 150 and marker 160, the region being opposed to the plurality of pin-holes 12a and the plurality of light emitting devices 32.

The light blocking layer 150 is disposed in contact with the spacer 140, and is disposed to be opposed to the support 11 or the light guide plate 92 through intermediation of the air gap 170. The light blocking layer 150 is flat, which is different from the case of the light blocking layer 70 of the above-described embodiment. The light blocking layer 150 has a function of blocking leakage of light (light of the light emitting device 32) that has propagated through the air gap 170 to the outside. The light blocking layer 150 is formed of an opaque material having a refractive index larger than the refractive index of the support 11 or the light guide plate 92. Here, “opaque” refers to a state of having a light blocking characteristic with respect to at least light emitted from the light emitting device 32. In a case where the support 11 is formed of a glass substrate (refractive index of 1.46), the air gap 170 is formed of, for example, a material having a refractive index of 1. This allows light of a wide angle of view to enter each pin-hole 12a.

The marker 160 is, for example, disposed in contact with the surface of the light blocking layer 150 on the air gap 170 side. The marker 160 is, for example, formed by printing onto the surface of the light blocking layer 150 on the air gap 170 side or embedding beads into the surface of the light blocking layer 150 on the air gap 170 side. The marker 160 functions as a reflection layer that reflects at least light of the light emitting device 32. The marker 160 is formed of a material having a reflecting characteristic with respect to at least light emitted from the light emitting device 32. The marker 160 has, for example, a grid shape. It is to be noted that the shape of the marker 160 is not limited to the grid shape, and may be, for example, a dot shape.

In a case where the marker 160 has a grid shape, when a portion of the light blocking layer 150 is pressed by a finger, for example, the marker 160 deforms into such a shape that a portion of the grid is expanded. At this time, the image data to be obtained by the sensor section 41 may include a marker image having such a shape that a portion of the grid is expanded.

The air gap 170 is surrounded by the light blocking layer 150 and the support 11 or the light guide plate 92, and is sealed (tightly-sealed) by the light blocking layer 150 and the support 11 or the light guide plate 92. At this time, for example, the air gap 170 may be charged with atmosphere, or may be charged with gas such as nitrogen. In such a case, when the light blocking layer 150 is pressed from the outside by an object and then the object separates away from the light blocking layer 150, it is possible to restore the shape of the light blocking layer 150 to the shape before the pressing with the elasticity of the air gap 170.

### 3. APPLICATION EXAMPLE

Next, description is given of a robot apparatus 200 in which the tactile sensor unit 1 is provided to a distal end portion of a robot arm unit 220. FIG. 26 illustrates a perspective configuration example of the robot apparatus 200. The robot apparatus 200 includes, for example, a main body 210, two robot arm units 220, a movement mechanism 230, and a plurality of non-contact sensors 240.

The main body 210 is, for example, a center part which includes a power section and a controller of the robot apparatus 200, and to which each section of the robot apparatus 200 is to be mounted. The controller controls the two robot arm units 220, the movement mechanism 230, and the plurality of non-contact sensors 240 provided in the robot apparatus 200. The main body 210 may have a shape resembling a human upper body including a head, a neck, and a body.

Each robot arm unit 220 is, for example, a multi-joint manipulator mounted to the main body 210. One robot arm unit 220 is, for example, mounted to a right shoulder of the main body 210 resembling the human upper body. Another robot arm unit 220 is, for example, mounted to a left shoulder of the main body 210 resembling the human upper body. One or a plurality of tactile sensor units 1 according to the embodiment or its modification example described above is mounted to a distal end portion of each robot arm unit 220.

The movement mechanism 230 is, for example, a part provided on a lower portion of the main body 210 and is responsible for movement of the robot apparatus 200. The movement mechanism 230 may be a two-wheeled or four-wheeled movement unit, or may be a two-legged or four-legged movement unit. Moreover, the movement mechanism 230 may be a hover-type, a propeller-type, or an endless-track-type movement unit.

The non-contact sensor 240 is, for example, a sensor that is provided on the main body 210 or the like to detect (sense) information regarding an environment (external environment) around the robot apparatus 200 in a non-contact manner. The non-contact sensor 240 outputs sensor data obtained through the detection (sensing). The non-contact sensor 240 is, for example, an imaging unit such as a stereo camera, a monocular camera, a color camera, an infrared camera, or a polarization camera. It is to be noted that the non-contact sensor 240 may be an environment sensor for use in detecting a weather or a meteorological phenomenon, a microphone that detects voice, or a depth sensor such as an ultrasonic sensor, a time of flight (ToF) sensor, or a light detection and ranging (LiDAR) sensor. The non-contact sensor 240 may be a position sensor such as a global navigation satellite system (GNSS) sensor.

In this application example, in the robot apparatus 200, one or a plurality of tactile sensor units 1 according to the embodiment or its modification example described above is mounted to the robot arm unit 220. This allows the robot arm unit 220 to be downsized, and hence it is possible to obtain high operability.

The present disclosure has been described above with reference to the embodiment, the modification examples, and the application example, but the present disclosure is not limited to the embodiment and the like, and is modifiable in a variety of ways. It is to be noted that the effects described herein are merely examples. The effects of the present disclosure are not limited to the effects described herein. The present disclosure may have effects other than the effects described herein.

Further, for example, the present disclosure may take the following configurations.

(1)

A tactile sensor unit including:
a pin-hole layer having a plurality of pin-holes and a plurality of first through holes;
an optical sensor opposed to the plurality of pin-holes via a predetermined gap;
a plurality of light sources disposed in a layer between the pin-hole layer and the optical sensor, at locations respectively opposed to the plurality of first through holes;
a deformation layer disposed at a position on a side opposite to the plurality of light sources in a positional relationship with respect to the pin-hole layer; and
a marker disposed on a surface of the deformation layer or inside of the deformation layer.
   (2)

The tactile sensor unit according to (1), further including a first light blocking layer disposed in a region between the pin-hole layer and the optical sensor, the first light blocking layer having a plurality of second through holes respectively communicating with the plurality of pin-holes and a plurality of third through holes respectively communicating with the plurality of first through holes, in which
each of the light sources is accommodated in a corresponding one of the third through holes.
   (3)

The tactile sensor unit according to (1) or (2), further including a second light blocking layer that is disposed to cover the deformation layer and the marker and blocks light of the light sources.

(4)

The tactile sensor unit according to (1) or (2), further including a light transmitting layer that is disposed to cover the deformation layer and the marker and allows external light to transmit therethrough.

(5)

The tactile sensor unit according to any one of (1) to (4), in which the marker functions as a reflection layer that reflects light of the light sources.

(6)

The tactile sensor unit according to any one of (1) to (5), in which each of the light sources includes a light emitting device.

(7)

The tactile sensor unit according to any one of (1) to (5), further including a light guide plate between the sensor and the light sources, in which
each of the light sources includes a scattering layer that outputs light propagating through the light guide plate toward the marker via a corresponding one of the first through holes.
   (8)

A robot arm unit including one or a plurality of tactile sensor units, the one or the plurality of tactile sensor units including:
a pin-hole layer having a plurality of pin-holes and a plurality of first through holes;
an optical sensor opposed to the plurality of pin-holes via a predetermined gap;
a plurality of light sources disposed in a layer between the pin-hole layer and the optical sensor, at locations respectively opposed to the plurality of first through holes;
a deformation layer disposed at a position on a side opposite to the plurality of light sources in a positional relationship with respect to the pin-hole layer; and
a marker disposed on a surface of the deformation layer or inside of the deformation layer.

The tactile sensor unit according to the first embodiment of the present disclosure and the robot arm unit according to the second embodiment of the present disclosure each use a plurality of pin-holes. This allows an optical path length to be shortened and also allows a depth of field to be increased as compared with a case of using a lens. In a case where the pin-holes are used to shorten the optical path length, it is possible to reduce the size of the tactile sensor unit itself. Further, in the present disclosure, the plurality of light sources is disposed in a layer between the pin-hole layer and the optical sensor, at locations respectively opposed to the plurality of through holes 12b. This prevents light emitted from each light source from directly entering the pin-hole, and hence it is possible to suppress stray light. Accordingly, it is possible to achieve downsizing and stray light suppression.

The present application claims the benefit of Japanese Priority Patent Application JP2021-194908 filed with the Japan Patent Office on Nov. 30, 2021, the entire contents of which are incorporated herein by reference.

It should be understood by those skilled in the art that various modifications, combinations, sub-combinations and alterations may occur depending on design requirements and other factors insofar as they are within the scope of the appended claims or the equivalents thereof.

1. A tactile sensor unit comprising:
a pin-hole layer having a plurality of pin-holes and a plurality of first through holes;
an optical sensor opposed to the plurality of pin-holes via a predetermined gap;
a plurality of light sources disposed in a layer between the pin-hole layer and the optical sensor, at locations respectively opposed to the plurality of first through holes;
a deformation layer disposed at a position on a side opposite to the plurality of light sources in a positional relationship with respect to the pin-hole layer; and
a marker disposed on a surface of the deformation layer or inside of the deformation layer.

2. The tactile sensor unit according to claim 1, further comprising a first light blocking layer disposed in a region between the pin-hole layer and the optical sensor, the first light blocking layer having a plurality of second through holes respectively communicating with the plurality of pin-holes and a plurality of third through holes respectively communicating with the plurality of first through holes, wherein
each of the light sources is accommodated in a corresponding one of the third through holes.

3. The tactile sensor unit according to claim 1, further comprising a second light blocking layer that is disposed to cover the deformation layer and the marker and blocks light of the light sources.

4. The tactile sensor unit according to claim 1, further comprising a light transmitting layer that is disposed to cover the deformation layer and the marker and allows external light to transmit therethrough.

5. The tactile sensor unit according to claim 1, wherein the marker functions as a reflection layer that reflects light of the light sources.

6. The tactile sensor unit according to claim 1, wherein each of the light sources comprises a light emitting device.

7. The tactile sensor unit according to claim 1, further comprising a light guide plate between the sensor and the light sources, wherein
each of the light sources comprises a scattering layer that outputs light propagating through the light guide plate toward the marker via a corresponding one of the first through holes.

8. A robot arm unit including one or a plurality of tactile sensor units, the one or the plurality of tactile sensor units comprising:
a pin-hole layer having a plurality of pin-holes and a plurality of first through holes;
an optical sensor opposed to the plurality of pin-holes via a predetermined gap;
a plurality of light sources disposed in a layer between the pin-hole layer and the optical sensor, at locations respectively opposed to the plurality of first through holes;
a deformation layer disposed at a position on a side opposite to the plurality of light sources in a positional relationship with respect to the pin-hole layer; and
a marker disposed on a surface of the deformation layer or inside of the deformation layer.
